(19) United States
(12) Patent Application Publication
(10) Pub. No.: US 2025/0282630 A1
(43) Pub. Date: Sep. 11, 2025

(54) Systems and Methods for Generating Bicarbonate Solution From Sodium Hydroxide and Carbon Dioxide

(71) Applicant: Carollo Engineers, Inc., Costa Mesa, CA (US)

(72) Inventors: Vincent Hart, Tampa, FL (US); Melanie Pickett, Tampa, FL (US); Greg Stanczak, Boise, ID (US); Yun Yu, Broomfield, CO (US)

(21) Appl. No.: 18/857,259

(22) PCT Filed: Mar. 28, 2024
(86) PCT No.: PCT/US2024/021999

§ 371 Date: Oct. 16, 2024

Related U.S. Application Data
(60) Provisional application No. 63/493,548, filed on Mar. 31, 2023.

(51) Int. Cl. C01D 7/07; B01J 4/00; B01J 10/00; B01J 19/00; B01J 19/24; C02F 1/66

(52) U.S. Cl. CPC C01D 7/07; B01J 4/004; B01J 4/008; B01J 10/002; B01J 19/0006; B01J 19/24; B01J 2204/002; B01J 2219/00164; C02F 1/66; C02F 2303/16

(57) ABSTRACT

A system for generating bicarbonate solution includes a reaction vessel having an inflow of water (H₂O) and sodium hydroxide (NaOH). The water and the sodium hydroxide combine to form a solution in the reaction vessel. The system also includes a gas sparger in fluid communication with the reaction vessel. The gas sparger provides an inflow of gas comprising carbon dioxide (CO₂) into the solution in the reaction vessel. The system also includes at least one flow regulating component upstream from the reaction vessel and in-line with at least one of the following: the inflow of the water, the inflow of the sodium hydroxide, the inflow of the gas comprising carbon dioxide, or any combination thereof. The system also includes a controller in communication with the at least one flow regulating component. The sodium hydroxide and the carbon dioxide react to form at least bicarbonate (HCO₃⁻) in the solution.

### CROSS REFERENCE TO RELATED APPLICATIONS

This application is the United States national phase of International Patent Application No. PCT/US24/21999 filed Mar. 28, 2024, and claims priority to U.S. Provisional Patent Application No. 63/493,548, entitled “Systems and Methods for Generating Bicarbonate Solution from Sodium Hydroxide and Carbon Dioxide”, filed Mar. 31, 2023, the disclosures of which are hereby incorporated by reference in their entireties.

### BACKGROUND

### Technical Field

The present disclosure relates to generation of bicarbonate. More particularly, it relates to a method and system for generating bicarbonate solution, such as for use in water treatment.

### Technical Description

Utilities commonly add carbon dioxide and sodium hydroxide to process water separately to create bicarbonate. Carbon dioxide solution feed systems are available, but due to the low solubility of carbonic acid, require a relatively high volume of carrier water (e.g., 1 gpm per lbs/hr of carbon dioxide feed).

Accordingly, those skilled in the art continue research and development in the field of bicarbonate solution generation.

### SUMMARY

In some non-limiting embodiments or aspects, a system for generating bicarbonate solution includes a reaction vessel having an inflow of water (H₂O) and sodium hydroxide (NaOH). The water and the sodium hydroxide combine to form a solution in the reaction vessel. The system for generating bicarbonate solution includes a gas sparger in fluid communication with the reaction vessel. The gas sparger provides an inflow of carbon dioxide (CO₂) gas into the solution in the reaction vessel. The system for generating bicarbonate solution includes at least one flow regulating component upstream from the reaction vessel and in-line with at least one of the following: the inflow of the water, the inflow of the sodium hydroxide, the inflow of the carbon dioxide gas, or any combination thereof. The system for generating bicarbonate solution includes a controller in communication with the at least one flow regulating component. The sodium hydroxide and the carbon dioxide react to form at least bicarbonate (HCO₃⁻) in the solution.

In some non-limiting embodiments or aspects, the controller can be configured to control a flow of the inflow of the water, the inflow of the sodium hydroxide, and the inflow of the carbon dioxide gas. In some non-limiting embodiments or aspects, the at least one flow regulating component can include at least one of the following: a valve, a pump, a rotameter, a nozzle, a solids feeder, a flow meter, or any combination thereof. In some non-limiting embodiments or aspects, the system for generating the bicarbonate solution can include a water supply upstream from the reaction vessel and in-line with at least the inflow of the water. In some non-limiting embodiments or aspects, the system for generating the bicarbonate solution can include a water softener upstream from the reaction vessel and in-line with at least the inflow of the water. In some non-limiting embodiments or aspects, the water softener can be configured to soften the water before the inflow into the reaction vessel. In some non-limiting embodiments or aspects, the system for generating the bicarbonate solution can include a sodium hydroxide holding vessel upstream from the reaction vessel and in-line with at least the inflow of the sodium hydroxide. In some non-limiting embodiments or aspects, the sodium hydroxide can be in a liquid solution in the holding vessel. In some non-limiting embodiments or aspects, the liquid solution can be between 30 and 60% by mass of the sodium hydroxide. In some non-limiting embodiments or aspects, the system for generating the bicarbonate solution can include a pressure vessel upstream from the gas sparger and in-line with at least the inflow of the carbon dioxide gas. In some non-limiting embodiments or aspects, the pressure vessel can be configured to hold carbon dioxide in liquid form. In some non-limiting embodiments or aspects, the system for generating the bicarbonate solution can include at least one detector in fluid communication with at least one of the following: the inflow of the water, the inflow of the sodium hydroxide, the inflow of the carbon dioxide gas, the solution in the reaction vessel, a headspace of the reaction vessel, or any combination thereof. In some non-limiting embodiments or aspects, the at least one detector can be in communication with the controller. In some non-limiting embodiments or aspects, the at least one detector can be configured to: detect at least one property of at least one of the following: the inflow of the water, the inflow of the sodium hydroxide, the inflow of the carbon dioxide gas, the solution in the reaction vessel, the gas in the headspace of the reaction vessel, or any combination thereof, and transmit the at least one property to the controller. In some non-limiting embodiments or aspects, the at least one property can be at least one of the following: a concentration, a pH, a temperature, a pressure, an alkalinity, a conductivity, a flow rate, a mass, a volume, or any combination thereof. In some non-limiting embodiments or aspects, the system for generating the bicarbonate solution can include a gas inlet in fluid communication with the reaction vessel. In some non-limiting embodiments or aspects, the gas inlet can be configured to introduce a gaseous pressure to at least one of the following: the solution in the reaction vessel, a headspace of the reaction vessel, or a combination thereof.

In some non-limiting embodiments or aspects, a method for generating bicarbonate solution includes flowing water (H₂O) into a vessel. The method for generating bicarbonate solution includes introducing sodium hydroxide (NaOH) into the vessel. The water and the sodium hydroxide combine to form a solution. The method for generating bicarbonate solution includes sparging carbon dioxide (CO₂) gas in the solution. The sodium hydroxide and the carbon dioxide react to form at least bicarbonate (HCO₃⁻) in the solution.

In some non-limiting embodiments or aspects, the method for generating the bicarbonate solution can include controlling a flow of the water, the sodium hydroxide, and the carbon dioxide gas with a controller. In some non-limiting embodiments or aspects, the method for generating the bicarbonate solution can include flowing the water through a water softener before flowing the water into the vessel. In some non-limiting embodiments or aspects, the method for generating the bicarbonate solution can include detecting at least one property of at least one of the following: the water flowing into the vessel, the sodium hydroxide flowing into the vessel, the carbon dioxide gas sparging in the solution, the solution in the vessel, the gas in a headspace of the vessel, or any combination thereof. In some non-limiting embodiments or aspects, the method for generating the bicarbonate solution can include transmitting the at least one property to the controller. In some non-limiting embodiments or aspects, the at least one property can be at least one of the following: a concentration, a pH, a temperature, a pressure, an alkalinity, a conductivity, a flow rate, a mass, a volume, or any combination thereof. In some non-limiting embodiments or aspects, the method for generating the bicarbonate solution can include introducing a gaseous pressure to at least one of the following: the solution in the reaction vessel, the headspace of the vessel, or a combination thereof. In some non-limiting embodiments or aspects, the method for generating the bicarbonate solution can include transferring the solution from the vessel after detecting the at least one property of at least one of the following: the water flowing into the vessel, the sodium hydroxide flowing into the vessel, the carbon dioxide gas sparging in the solution, the solution in the vessel, the gas in the headspace of the vessel, or any combination thereof.

Further non-limiting embodiments or aspects of the present disclosure are set forth in the following numbered clauses.

Clause 1: A system for generating bicarbonate solution, comprising: a reaction vessel comprising an inflow of water (H₂O) and sodium hydroxide (NaOH), wherein the water and the sodium hydroxide combine to form a solution in the reaction vessel; a gas sparger in fluid communication with the reaction vessel, the gas sparger comprising an inflow of gas comprising carbon dioxide (CO₂) into the solution in the reaction vessel; at least one flow regulating component upstream from the reaction vessel and in-line with at least one of the following: the inflow of the water, the inflow of the sodium hydroxide, the inflow of the gas comprising carbon dioxide, or any combination thereof; and a controller in communication with the at least one flow regulating component, wherein the sodium hydroxide and the carbon dioxide react to form at least bicarbonate (HCO₃⁻) in the solution.

Clause 2: The system for generating the bicarbonate solution of Clause 1, wherein the controller is configured to control a flow of the inflow of the water, the inflow of the sodium hydroxide, and the inflow of the gas comprising carbon dioxide.

Clause 3: The system for generating the bicarbonate solution of Clause 1 or Clause 2, wherein the at least one flow regulating component comprises at least one of the following: a valve, a pump, a rotameter, a nozzle, a solids feeder, a flow meter, or any combination thereof.

Clause 4: The system for generating the bicarbonate solution of any of Clauses 1-3, further comprising: a water supply upstream from the reaction vessel and in-line with at least the inflow of the water.

Clause 5: The system for generating the bicarbonate solution of any of Clauses 1-4, further comprising: a water softener upstream from the reaction vessel and in-line with at least the inflow of the water, wherein the water softener is configured to soften the water before the inflow into the reaction vessel.

Clause 6: The system for generating the bicarbonate solution of any of Clauses 1-5, further comprising: a sodium hydroxide holding vessel upstream from the reaction vessel and in-line with at least the inflow of the sodium hydroxide, wherein the sodium hydroxide comprises a liquid solution in the holding vessel.

Clause 7: The system for generating the bicarbonate solution of any of Clauses 1-6, wherein the liquid solution is between 30 and 60% by mass of the sodium hydroxide.

Clause 8: The system for generating the bicarbonate solution of any of Clauses 1-7, further comprising: a pressure vessel upstream from the gas sparger and in-line with at least the inflow of the gas comprising carbon dioxide, wherein the pressure vessel is configured to hold carbon dioxide in liquid form.

Clause 9. The system for generating the bicarbonate solution of any of Clauses 1-8, further comprising: at least one detector in fluid communication with at least one of the following: the inflow of the water, the inflow of the sodium hydroxide, the inflow of the gas comprising carbon dioxide, the solution in the reaction vessel, a headspace of the reaction vessel, or any combination thereof.

Clause 10: The system for generating the bicarbonate solution of any of Clauses 1-9, wherein the at least one detector is in communication with the controller.

Clause 11: The system for generating the bicarbonate solution of any of Clauses 1-10, wherein the at least one detector is configured to: detect at least one property of at least one of the following: the inflow of the water, the inflow of the sodium hydroxide, the inflow of the gas comprising carbon dioxide, the solution in the reaction vessel, the gas in the headspace of the reaction vessel, or any combination thereof; and transmit the at least one property to the controller.

Clause 12: The system for generating the bicarbonate solution of any of Clauses 1-11, wherein the at least one property is at least one of the following: a concentration, a pH, a temperature, a pressure, an alkalinity, a conductivity, a flow rate, a mass, a volume, or any combination thereof.

Clause 13: The system for generating the bicarbonate solution of any of Clauses 1-12, further comprising: a gas inlet in fluid communication with the reaction vessel, wherein the gas inlet is configured to introduce a gaseous pressure to at least one of the following: the solution in the reaction vessel, a headspace of the reaction vessel, or a combination thereof.

Clause 14: A method for generating bicarbonate solution, comprising: flowing water (H₂O) into a vessel; introducing sodium hydroxide (NaOH) into the vessel, wherein the water and the sodium hydroxide combine to form a solution; and sparging a gas comprising carbon dioxide (CO₂) in the solution, wherein the sodium hydroxide and the carbon dioxide react to form at least bicarbonate (HCO₃⁻) in the solution.

Clause 15: The method for generating the bicarbonate solution of Clause 14, further comprising: controlling a flow of the water, the sodium hydroxide, and the gas comprising carbon dioxide with a controller.

Clause 16: The method for generating the bicarbonate solution of Clause 14 or Clause 15, further comprising: flowing the water through a water softener before flowing the water into the vessel.

Clause 17: The method for generating the bicarbonate solution of any of Clauses 14-16, further comprising: detecting at least one property of at least one of the following: the water flowing into the vessel, the sodium hydroxide flowing into the vessel, the gas comprising carbon dioxide sparging in the solution, the solution in the vessel, the gas in a headspace of the vessel, or any combination thereof.

Clause 18: The method for generating the bicarbonate solution of any of Clauses 14-17, further comprising: transmitting the at least one property to the controller, wherein the at least one property is at least one of the following: a concentration, a pH, a temperature, a pressure, an alkalinity, a conductivity, a flow rate, a mass, a volume, or any combination thereof.

Clause 19: The method for generating the bicarbonate solution of any of Clauses 14-18, further comprising: introducing a gaseous pressure to at least one of the following: the solution in the reaction vessel, the headspace of the vessel, or a combination thereof.

Clause 20: The method for generating the bicarbonate solution of any of Clauses 14-19, further comprising: transferring the solution from the vessel after detecting the at least one property of at least one of the following: the water flowing into the vessel, the sodium hydroxide flowing into the vessel, the gas comprising carbon dioxide sparging in the solution, the solution in the vessel, the gas in the headspace of the vessel, or any combination thereof.

### BRIEF DESCRIPTION OF THE DRAWINGS

FIG. 1 is a schematic view of a system for generating bicarbonate solution, according to some non-limiting embodiments or aspects of the present disclosure;

FIG. 2 is a perspective view of a system for generating bicarbonate solution, according to some non-limiting embodiments or aspects of the present disclosure;

FIG. 3 is a view of a gas sparger in fluid communication with a reaction vessel, according to some non-limiting embodiments or aspects of the present disclosure;

FIG. 4 is a view of a graph displaying a relationship between elapsed sparge time and pH, and before sparge and after sparge alkalinity values, of various concentrations of sodium hydroxide solutions exposed to a carbon dioxide sparge, according to some non-limiting embodiments or aspects of the present disclosure; and

FIG. 5 is a view of multiple graphs displaying a relationship between elapsed sparge time and pH, and before sparge and after sparge alkalinity and conductivity values, of two concentrations of sodium hydroxide solutions exposed to a carbon dioxide sparge, according to some non-limiting embodiments or aspects of the present disclosure.

Corresponding reference characters indicate corresponding features throughout the several views of the drawings. The representations set out herein illustrate exemplary aspects of the disclosure, and such representations are not to be construed as limiting the scope of the disclosure in any manner.

### DETAILED DESCRIPTION

While this disclosure is made as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

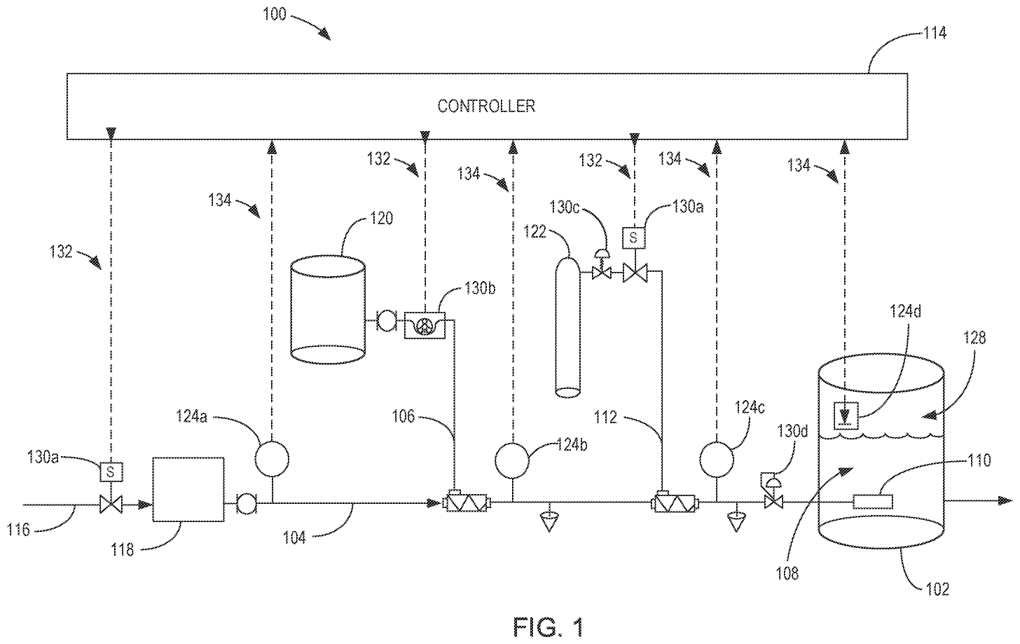

Referring to FIGS. 1-3, the disclosed system 100 and method can include generating bicarbonate solution via in situ sparging a sodium hydroxide (NaOH) solution with carbon dioxide gas (CO₂). The disclosed system 100 and method may be implemented in lieu of the conventional dissolution approach that includes using sodium bicarbonate (NaHCO₃) dry powder. The use of bicarbonate for anion exchange resin regeneration during water treatment eases waste regenerant disposal, as biological nitrification processes may benefit from the presence of bicarbonate if the waste regenerant is recycled to the municipal wastewater treatment plant. As will be described below, the bicarbonate solution may be produced by the system 100 and method using diluted sodium hydroxide solution mixed with carbon dioxide gas. The bicarbonate solution may be useful for various applications, such as in water treatment as described below. Water treatment by bicarbonate addition can also be utilized by utilities that require alkalinity addition due to low alkalinity conditions of source water. Utilization of the system 100 and method for generating bicarbonate solution significantly broadens the applicability of bicarbonate at a large scale for water stability, pH control, control of corrosion, and the ion exchange regeneration process.

Carbon dioxide solution generation is typically limited due to the relatively low solubility of carbon dioxide in water (i.e., 0.348 g carbon dioxide per liter of water). The disclosed system 100 and method solves the carbon dioxide solubility issue and the reaction vessel 102 can operate under ambient pressures, which improves safety. However, as will be described below, the reaction vessel 102 of the system 100 for generating bicarbonate solution can also operate under any backpressure needed, in which the backpressure is applied to the headspace 128 of the reaction vessel 102. For example, the reaction vessel 102 of the system 100 for generating bicarbonate solution can operate under any backpressure needed to keep carbonic acid (H₂CO₃) in the solution 108 in the reaction vessel 102.

The disclosed system 100 and method may be implemented for alkalinity addition at water treatment plants as well as for ion exchange (IX) regeneration processes, such as anion exchange resin regeneration. Conventional IX treatment utilizes a chloride-based regenerant solution and is susceptible to elevated chloride concentration as a result of ion exchange. Chloride will result in adverse outcomes, such as enhanced corrosivity, increased salinity to treated waters, increased demands in waste regenerant disposal including large dilution of waste regenerant, and the potential to exacerbate lead release in drinking water distribution systems.

The disclosed system 100 and method may be implemented with anion exchange processes, such as a suspended ion exchange process, by utilizing the produced bicarbonate counter ions to eliminate the adverse impact of chloride. In one aspect of the disclosed system 100 and method, bicarbonate may be used as a mobile counter ion in anion exchange processes. The disclosed features allow bicarbonate regeneration to be effectively used in IX processes, such as suspended ion exchange processes.

In other non-limiting examples, the disclosed system 100 and method can be used to provide bicarbonate for use in drinking water treatment plants that have low source water alkalinities, require alkalinity addition, and do not rely on a dry chemical. Low source water alkalinities produce drinking water that is poorly buffered and susceptible to pH drop if nitrification events occur (usually tied to the use of chloramines). The corresponding pH drop of a poorly buffered water can create corrosive water and result in the conversion of monochloramine to di- and trichloramines which eliminates disinfection protection.

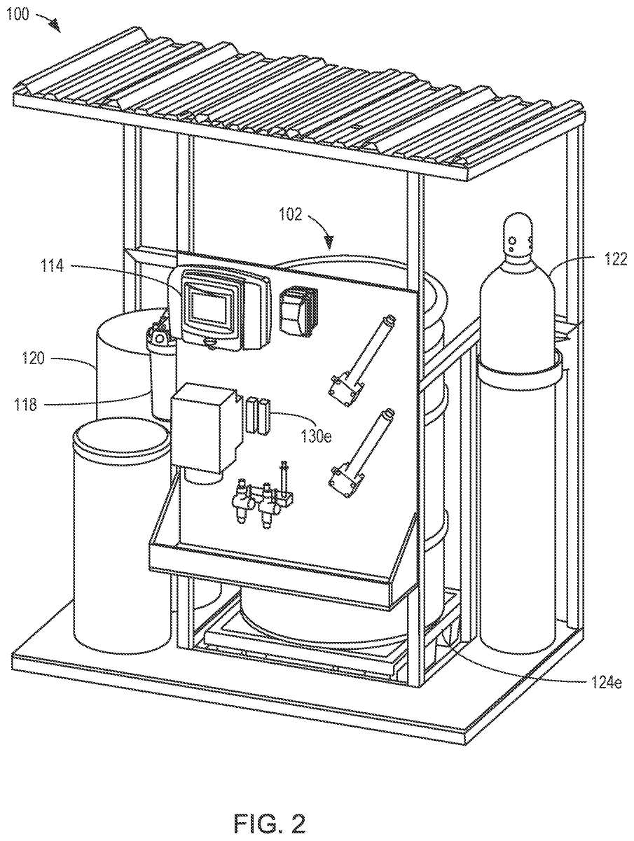

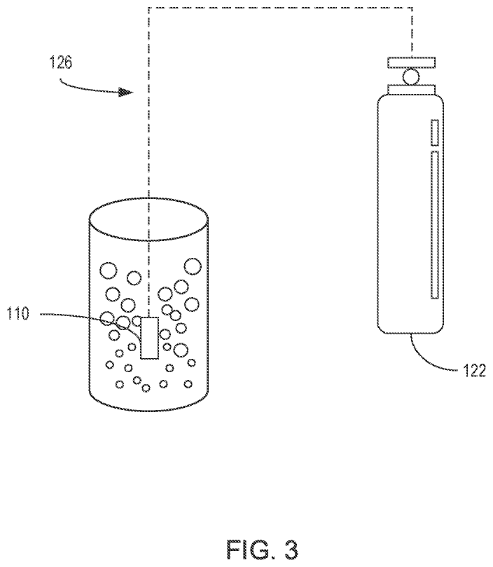

Referring to FIG. 1, there is shown a view of a system 100 for generating bicarbonate solution, according to some non-limiting embodiments or aspects of the present disclosure. Referring to FIG. 2, there is shown a perspective view of a system 100 for generating bicarbonate solution, according to some non-limiting embodiments or aspects of the present disclosure. Referring to FIG. 3, there is shown a view of a gas sparger 110 in fluid communication with a reaction vessel 102, according to some nonlimiting embodiments or aspects of the present disclosure.

Referring to FIGS. 1-3, the system 100 for generating bicarbonate solution includes a reaction vessel 102 having an inflow 104 of water and an inflow 106 of sodium hydroxide (NaOH). The water and the sodium hydroxide combine to form a solution 108 in the reaction vessel 102. The system 100 for generating bicarbonate solution also includes a gas sparger 110 in fluid communication with the reaction vessel 102. The gas sparger 110 provides an inflow 112 of gas including carbon dioxide (CO₂), such as a gas that is pure or nearly pure (e.g., 95% or more such as 99% or more CO₂), into the solution 108 in the reaction vessel 102. In one embodiment, inflow 104, inflow 106, and inflow 112 all enter the reaction vessel 102 through the same inlet and may be combined prior to entering the reaction vessel 102. In another embodiment, inflow 104, inflow 106, and inflow 112 each enter the reaction vessel 102 through a different inlet, such as their own respective inlets, and are not combined or mixed prior to entering the reaction vessel 102. In yet another embodiment, inflow 104 and inflow 106 enter the reaction vessel through the same inlet, while inflow 112 enters the reaction vessel 102 through a different inlet. The sodium hydroxide and the carbon dioxide react to form at least bicarbonate (HCO₃⁻) in the solution 108. As used herein, the term “inflow” may refer to an amount of a liquid, a gas, or a solid that moves or is transferred into place. For example, an inflow of sodium hydroxide can include an amount of liquid sodium hydroxide solution that moves or is transferred into place. In another embodiment, an inflow of sodium hydroxide can include an amount of solid sodium hydroxide that moves or is transferred into place.

The gas sparger 110 can be any device that is capable of introducing the carbon dioxide gas to the solution 108 in the reaction vessel 102. As shown in FIG. 3, the gas sparger 110 can be positioned in the solution 108 in the reaction vessel 102. With the gas sparger 110 positioned in the solution in the reaction vessel 102, the carbon dioxide gas directly contacts the solution 108 and agitates the solution 108 during introduction. The gas sparger 110 can be designed and utilized to increase the interaction of the inflow 112 of the carbon dioxide gas and the solution 108 in the reaction vessel. In one embodiment, the gas sparger 110 can include a feed pipe and an injector or a nozzle at the end of the feed pipe. The injector or nozzle can include an opening or pores that allow the carbon dioxide gas to exit the feed pipe and contact the solution 108 in the reaction vessel 102. In some non-limiting embodiments, the gas sparger 110 includes numerous small pores that create bubbles containing carbon dioxide gas that are introduced into the solution 108. In another embodiment, the system 100 for generating bicarbonate solution can include multiple gas spargers 110 in fluid communication with the reaction vessel 102.

Referring to FIGS. 1 and 2, the system 100 for generating bicarbonate solution can include a controller 114 in communication with the inflow 104 of the water, the inflow 106 of the sodium hydroxide, and the inflow 112 of the carbon dioxide gas. In one embodiment, the controller 114 can be a computing device. The computing device can be one or more electronic device(s) that is/are configured to process data. Each computing device can include a processor, a user interface, an input device, a display, a memory, a network interface, etc. That is, each computing device can include any components necessary to receive, store, process, and/or output data.

As used herein, the phrase “in communication” may refer to a relationship capable of reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

The controller 114 can be configured to control a flow of the inflow 104 of the water, a flow of the inflow 106 of the sodium hydroxide, and a flow of the inflow 112 of the carbon dioxide gas. In one embodiment, the system 100 can include one or more flow regulating component(s) 130. The system 100 for generating bicarbonate solution can include at least one flow regulating component 130 upstream from the reaction vessel 102 and in-line with at least one of the following: the inflow 104 of the water, the inflow 106 of the sodium hydroxide, the inflow 112 of the carbon dioxide gas, or any combination thereof. Specifically, the system 100 for generating bicarbonate solution can include at least one flow regulating component 130a upstream from the reaction vessel 102 and in-line with the inflow 104 of the water, at least one flow regulating component 130b upstream from the reaction vessel 102 and in-line with the inflow 106 of the sodium hydroxide, and at least one flow regulating component 130a, 130c, 130d, 130e upstream from the reaction vessel 102 and in-line with the inflow 112 of the carbon dioxide gas. The controller 114 can be in communication with the at least one flow regulating component 130, 130a, 130b via a first communication connection 132.

Each flow regulating component 130 can be a valve, a pump, a rotameter, a nozzle, a solids feeder, a flow meter, etc. Flow regulating component 130a can be a solenoid valve, flow regulating component 130b can be a pump, flow regulating component 130c can be a pressure regulator valve, flow regulating component 130d can be a back pressure valve, and flow regulating component 130e can be a rotameter. Solenoid valve 130a that is in-line with the inflow 104 of the water can allow the water to enter the system 100 from a water supply 116. The inflow 104 of the water can also include a flow meter (not shown) that measures the incoming flow of the water. Solenoid valve 130a that is in-line with the inflow 112 of the carbon dioxide gas can allow the carbon dioxide gas to enter the system 100 from a pressure vessel 122. Pump 130b that is in-line with the inflow 106 of the sodium hydroxide can allow the sodium hydroxide to enter the system 100 from a sodium hydroxide holding vessel 120. Pressure regulator valve 130c that is in-line with the inflow 112 of the carbon dioxide gas can regulate the pressure of the carbon dioxide gas entering the solenoid valve 130a from the pressure vessel 122. Back pressure valve 130d that is in-line with the inflow 112 of the carbon dioxide gas can apply a back pressure to the inflow 112 of the carbon dioxide gas in order to increase carbon dioxide solubility in the solution 108 in the reaction vessel 102. Rotameter 130e (shown in FIG. 2) that is in-line with the inflow 112 of the carbon dioxide gas can regulate the flowrate of the carbon dioxide gas entering the reaction vessel 102.

The controller 114 can be configured to control the flow of the inflow 104 of the water, the flow of the inflow 106 of the sodium hydroxide, and the flow of the inflow 112 of the carbon dioxide gas by, for example, communicating with the at least one flow regulating component 130, 130a, 130b via the first communication connection 132. In one embodiment, each of the inflow 104 of the water, the inflow 106 of the sodium hydroxide, and the inflow 112 of the carbon dioxide gas can include a flow regulating component 130, 130a, 130b, and the controller 114 can communicate with each flow regulating component 130, 130a, 130b via a first communication connection 132 for each flow regulating component 130, 130a, 130b. The controller 114 can communicate with each flow regulating component 130, 130a, 130b by, for example, increasing or decreasing a flow rate through the flow regulating component 130, 130a, 130b and/or permitting or stopping a flow through the flow regulating component 130, 130a, 130b. The controller 114 can communicate with each flow regulating component 130, 130a, 130b by, for example, transmitting data to each flow regulating component 130, 130a, 130b thereby increasing or decreasing a flow rate through the flow regulating component 130, 130a, 130b and/or permitting or stopping a flow through the flow regulating component 130, 130a, 130b via the first communication connection 132.

The system 100 for generating bicarbonate solution can include a water supply 116 upstream from the reaction vessel 102 and in-line with at least the inflow 104 of the water. The water supply 116 can include a feed line/pipe or a holding tank.

The system 100 for generating bicarbonate solution can include a water softener 118 upstream from the reaction vessel 102 and in-line with at least the inflow 104 of the water. The water softener 118 can be configured to soften the water before the inflow 104 into the reaction vessel 102. The water softener 118 can be any device that is capable of removing calcium (Ca²⁺), magnesium (Mg²⁺), and other metal ions from the water supply 116 before the inflow 104 into the reaction vessel 102. In one non-limiting example, the water softener 118 can include cation exchange resin beads comprising sodium counter ions. The sodium ions are exchanged with calcium and magnesium ions in the water supply 116 to remove those minerals from the water supply 116.

The system 100 for generating bicarbonate solution can include a sodium hydroxide holding vessel 120 upstream from the reaction vessel 102 and in-line with at least the inflow 106 of the sodium hydroxide. The sodium hydroxide can be in a liquid solution in the holding vessel 120, such as in a concentrated liquid solution with a high amount of sodium hydroxide (e.g., a % by mass of sodium hydroxide that is higher than the % by mass of sodium hydroxide in solution 108). In one embodiment, the liquid solution is between 30 and 60% by mass, such as 50% by mass, of sodium hydroxide. When the sodium hydroxide solution contained in the sodium hydroxide holding vessel 120 is provided to the reaction vessel 102, it mixes with water from water supply 116 so as to dilute the sodium hydroxide content in solution 108 to a target value, such as a value of between 1% and 5% by mass, or between 2% and 4% by mass, of sodium hydroxide.

The system 100 for generating bicarbonate solution can include a pressure vessel 122 upstream from the gas sparger 110 and in-line with at least the inflow 112 of the carbon dioxide gas. The pressure vessel 122 can be configured to hold the carbon dioxide gas, which may be in liquid form if maintained under sufficient pressure in the pressure vessel 122. The pressure vessel 122 can be configured to hold the carbon dioxide gas at a pressure that is greater than an ambient pressure, such as a pressure of 75 psi or greater. As shown in FIG. 2, the pressure vessel 122 can be a gas cylinder configured to hold carbon dioxide in liquid form under pressure. Nonetheless, the source of carbon dioxide can be either pure carbon dioxide gas or carbon dioxide that is extracted from the air using a packed tower.

In one embodiment, the water from the water supply 116 is passed through the water softener 118 and transferred to the reaction vessel 102. Then, the sodium hydroxide is transferred to the reaction vessel 102. The water and the sodium hydroxide are then recirculated through the reaction vessel 102 at a high flowrate, while the carbon dioxide is introduced to the solution 108 in the reaction vessel 102. The introduction of the carbon dioxide during recirculation of the solution 108 in the reaction vessel 102 allows dissolution of the carbon dioxide into the solution 108 in the reaction vessel 102 at a higher concentration and a faster rate and generates backpressure in the reaction vessel 102.

The system 100 for generating bicarbonate solution can include at least one detector 124 in fluid communication with at least one of the following: the inflow 104 of the water, the inflow 106 of the sodium hydroxide, the inflow 112 of the carbon dioxide gas, the solution 108 in the reaction vessel 102, or any combination thereof. As shown in FIG. 1, the system 100 can include various detectors 124, 124a-124d in fluid communication with each of the inflow 104 of the water, the inflow 106 of the sodium hydroxide, the inflow 112 of the carbon dioxide gas, and the solution 108 in the reaction vessel 102. Specifically, the system 100 can include a detector 124a in fluid communication with the inflow 104 of the water, a detector 124b in fluid communication with the inflow 106 of the sodium hydroxide, a detector 124c in fluid communication with the inflow 112 of the carbon dioxide gas, and a detector 124d in fluid communication with the solution 108 in the reaction vessel 102. In one embodiment, the detector(s) 124, 124a-124d are in contact with the inflow 104 of the water, the inflow 106 of the sodium hydroxide, the inflow 112 of the carbon dioxide gas, and/or the solution 108 in the reaction vessel 102. In another embodiment, the detectors 124, 124a-124d are adjacent to or in proximity to the inflow 104 of the water, the inflow 106 of the sodium hydroxide, the inflow 112 of the carbon dioxide gas, and/or the solution 108 in the reaction vessel 102.

The at least one detector 124, 124a-124d can be in communication with the controller 114 via a second communication connection 134. The at least one detector 124, 124a-124d can be configured to detect at least one property of at least one of the following: the inflow 104 of the water, the inflow 106 of the sodium hydroxide, the inflow 112 of the carbon dioxide gas, the solution 108 in the reaction vessel 102, or any combination thereof. The at least one detector 124, 124a-124d can also be configured to transmit the at least one property to the controller 114 via the second communication connection 134. In one embodiment, the at least one detector 124, 124a-124d can communicate with the controller 114 by, for example, transmitting data to the controller 114 via the second communication connection 134. The data transmitted to the controller 114 by the detector 124, 124a-124d can be the at least one property detected by the detector 124, 124a-124d. The at least one property detected by the at least one detector 124, 124a-124d can be at least one of the following: a concentration, a pH, a temperature, a pressure, an alkalinity, a conductivity, a flow rate, a mass, a volume, or any combination thereof.

For example, the detector 124 can detect a concentration (e.g., mass of solute/total mass of solution) of sodium hydroxide in the inflow 106 of the sodium hydroxide and/or the solution 108 in the reaction vessel 102. The detector 124 can detect a flow rate of the inflow 104 of the water and a flow rate of the inflow 106 of the sodium hydroxide. The detector 124 can detect a pH of the solution 108 in the reaction vessel 102 before exposure to a sparge of carbon dioxide gas and after exposure to a sparge of carbon dioxide gas. The detector 124 can detect an alkalinity (e.g., mg/L as CaCO₃ or milligrams per liter as calcium carbonate) of the solution 108 in the reaction vessel 102 before exposure to a sparge of carbon dioxide gas and after exposure to a sparge of carbon dioxide gas. The detector 124 can detect a conductivity (e.g., mS/cm or millisiemens per centimeter) of the solution 108 in the reaction vessel 102 before exposure to a sparge of carbon dioxide gas and after exposure to a sparge of carbon dioxide gas. The detector 124 can detect a conductivity (e.g., mS/cm or millisiemens per centimeter) of the inflow 104 of the water before mixing with the inflow 106 of the sodium hydroxide and after mixing with the inflow 106 of the sodium hydroxide. The detector 124 can detect a conductivity (e.g., mS/cm or millisiemens per centimeter) of the inflow 104 of the water before flowing the water through the water softener 118 and after flowing the water through the water softener 118. The detector 124 can detect a flow rate of at least one of the following: the inflow 104 of the water, the inflow 106 of the sodium hydroxide, the inflow 112 of the carbon dioxide gas, or any combination thereof. The detector 124 can detect a mass or volume of the solution 108 in the reaction vessel 102. The detector 124 can transmit any of the foregoing data and/or properties to the controller 114. The controller 114 can then receive, store, process, and/or output any of the foregoing data and/or properties.

In one embodiment, detector 124a can be a flow meter, detector 124b can be a conductivity sensor, detector 124c can be pH sensor and/or a temperature sensor, detector 124d can be a level sensor, and detector 124e (shown in FIG. 2) can be a scale. The reaction vessel 102 can also include a detector 124 as a pressure sensor (not shown) that measures a pressure within the reaction vessel 102. The flow meter 124a can measure a flowrate of the inflow 104 of the water from the water supply 116. The conductivity sensor 124b can detect a conductivity of the solution 108. The pH sensor 124c can detect a pH of the solution 108. The level sensor 124d can detect a level or height of the solution 108 in the reaction vessel 102. The scale 124e (shown in FIG. 2) can detect a mass of the solution 108 in the reaction vessel.

In one embodiment, the at least one property (such as a concentration, a pH, a temperature, a pressure, an alkalinity, a conductivity, a flow rate, a mass, a volume, or any combination thereof) detected by the at least one detector 124, 124a-124d can be transmitted to the controller 114, and the controller 114 can receive and process the at least one property and can control the flow regulating component 130, 130a, 130b based on the at least one property. For example, the detector 124 can detect the at least one property (such as a concentration, a pH, a temperature, a pressure, an alkalinity, a conductivity, a flow rate, a mass, a volume, or any combination thereof) and transmit the at least one property to the controller 114, and the controller 114 can receive and process the at least one property and can control the flow regulating component 130, 130a, 130b by increasing or decreasing a flow rate through the flow regulating component 130, 130a, 130b and/or permitting or stopping flow through the flow regulating component 130, 130a, 130b. In one embodiment, the flow meter 124a can detect a flowrate of the inflow 104 of the water from the water supply 116 and transmit the flowrate to the controller 114, and the controller 114 can receive and process the flowrate and can control the pump 130b to introduce a desired amount of sodium hydroxide so as to dilute the sodium hydroxide content in solution 108 to a target value, such as a value of from approximately 50% to 1% by mass.

Referring to FIGS. 1-3, the system 100 for generating bicarbonate solution can include a gas inlet 126 in fluid communication with the reaction vessel 102. The gas inlet 126 can be configured to introduce a gaseous pressure to the solution 108 in the reaction vessel and/or a headspace 128 of the reaction vessel 102. In one embodiment as shown in FIG. 3, the gas inlet 126 can be the same line or pipe that produces the inflow 112 of carbon dioxide gas into the solution 108 in the reaction vessel 102. The gas inlet 126 can be configured to introduce a gaseous pressure to a headspace 128 of the reaction vessel 102 even if it is done indirectly. For example, if the gas inlet 126 is the same line or pipe that produces the inflow 112 of carbon dioxide gas into the solution 108 in the reaction vessel, the gas inlet can indirectly introduce a gaseous pressure to a headspace 128 of the reaction vessel 102 because the inflow 112 of the carbon dioxide gas that is not consumed by the reaction with sodium hydroxide rises to the headspace 128 of the reaction vessel 102. In another embodiment, the gas inlet 126 can be a different line or pipe than the line or pipe that produces the inflow 112 of carbon dioxide gas into the solution 108 in the reaction vessel 102. The reaction vessel 102 of the system 100 for generating bicarbonate solution can operate under any backpressure needed, in which the backpressure is applied to the reaction vessel 102 (with or without a headspace 128). For example, the reaction vessel 102 of the system 100 for generating bicarbonate solution can operate under any backpressure needed to keep the carbon dioxide gas dissolved in the solution 108 in the reaction vessel 102. The carbon dioxide gas dissolved in the solution 108 in the reaction vessel 102 can exist as carbonic acid (H₂CO₃), carbonate (CO₃²⁻), and/or bicarbonate (HCO₃⁻). However, backpressure is not necessary if the minimum solubility of carbonic acid (H₂CO₃), carbonate (CO₃²⁻), and/or bicarbonate (HCO₃⁻) is not exceeded. Nonetheless, higher backpressure will encourage more of the carbon dioxide gas to dissolve in the solution 108 in the reaction vessel 102 in the form of carbonic acid (H₂CO₃), carbonate (CO₃²⁻), and/or bicarbonate (HCO₃⁻).

In one embodiment as shown in FIG. 2, the system 100 for generating bicarbonate solution can be a self-contained unit or module. That is, each element of the system 100 for generating bicarbonate solution can be present on an independent base, platform, area, or footprint. In this way, the self-contained system 100 can easily be installed and implemented by a user of the system 100 with minimal installation requirements. In another embodiment, the system 100 for generating bicarbonate solution can be a nearly complete self-contained unit or module. For example, the system 100 may include every element except for the consumable elements, such as the water supply 116, a source of power or electricity, the sodium hydroxide, and/or the carbon dioxide. All that may be required by the user is installation of a water supply 116 to the system 100, installation of a source of power or electricity to the system 100, and/or introduction of the sodium hydroxide and the carbon dioxide to the system 100. In this way, the system 100 can still be easily installed and implemented by the user.

The system 100 for generating bicarbonate solution can include any components and/or equipment necessary to establish connection between the elements thereof. For example, the system 100 for generating bicarbonate solution can include piping, process equipment, instrumentation, control devices, etc. that establish connection between the elements of the system 100.

The present disclosure also relates to a method for generating bicarbonate solution. The method for generating bicarbonate solution can include flowing water into a vessel, introducing sodium hydroxide into the vessel, in which the water and the sodium hydroxide combine to form a solution, and sparging a gas comprising carbon dioxide in the solution. The sodium hydroxide and the carbon dioxide react to form at least bicarbonate (HCO₃⁻) in the solution. The method for generating bicarbonate solution can utilize any of the above-described elements of the system 100 for generating bicarbonate solution.

The method for generating bicarbonate solution can include controlling the flow of the water, the flow of sodium hydroxide, and the flow of the carbon dioxide gas with a controller. The method for generating bicarbonate solution can include flowing the water through a water softener before flowing the water into the vessel. The method for generating bicarbonate solution can include detecting at least one property of at least one of the following: the water flowing into the vessel, the sodium hydroxide flowing into the vessel, the carbon dioxide gas sparging in the solution, the solution in the vessel, the gas in a headspace of the vessel or any combination thereof. The method for generating bicarbonate solution can include transmitting the at least one property to the controller. The at least one property is at least one of the following: a concentration, a pH, a temperature, a pressure, an alkalinity, a conductivity, a flow rate, a mass, a volume, or any combination thereof. The method for generating bicarbonate solution can include introducing a gaseous pressure to at least one of the following: the solution in the vessel, the headspace of the vessel, or a combination thereof. The method for generating bicarbonate solution can include transferring the solution from the vessel after detecting the at least one property of at least one of the following: the water flowing into the vessel, the sodium hydroxide flowing into the vessel, the carbon dioxide gas sparging in the solution, the solution in the vessel, the gas in the headspace of the vessel, or any combination thereof.

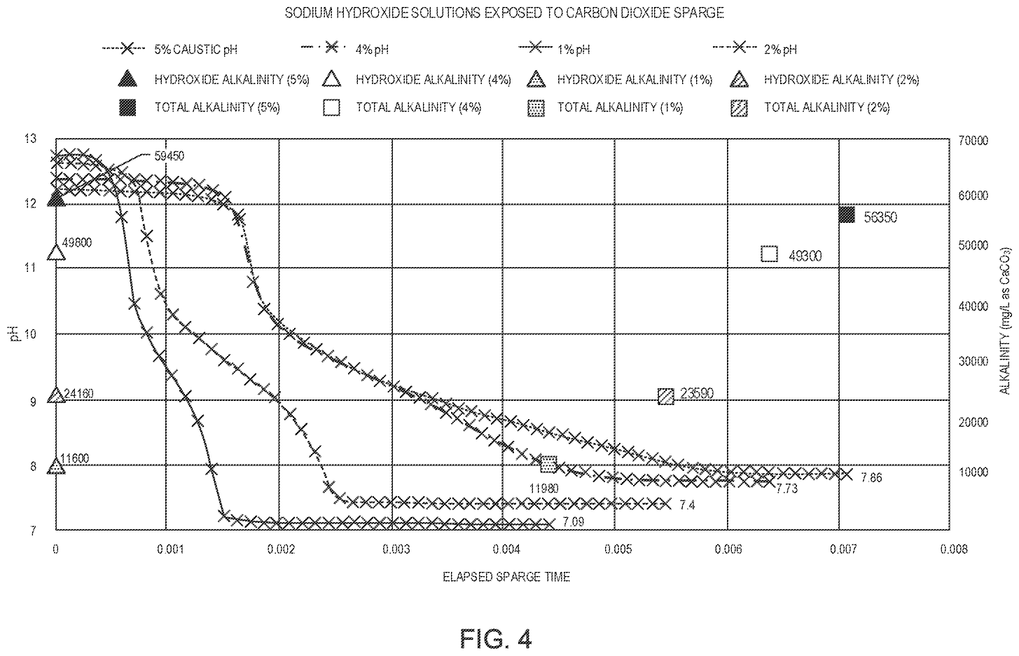

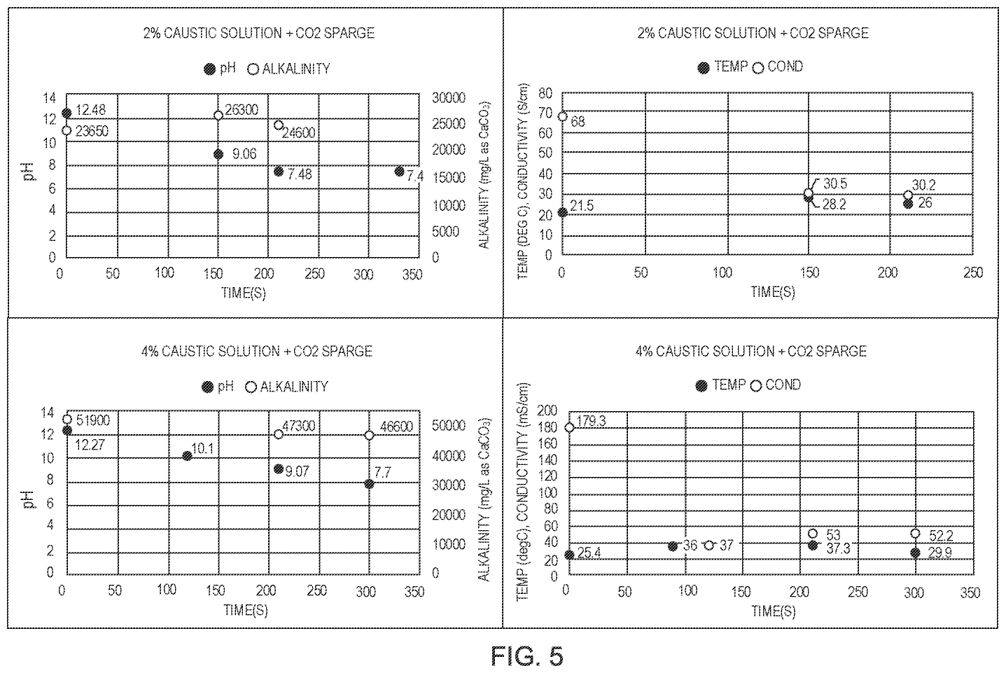

Referring to FIG. 4, there is shown a view of a graph displaying a relationship between elapsed sparge time and pH, and before sparge and after sparge alkalinity values, of various concentrations of sodium hydroxide solutions exposed to a carbon dioxide sparge, according to some non-limiting embodiments or aspects of the present disclosure. Referring to FIG. 5, there is shown a view of multiple graphs displaying a relationship between elapsed sparge time and pH, and before sparge and after sparge alkalinity and conductivity values, of two concentrations of sodium hydroxide solutions exposed to a carbon dioxide sparge, according to some non-limiting embodiments or aspects of the present disclosure.

Referring to FIG. 4, there is shown a graph of multiple sodium hydroxide solutions exposed to a carbon dioxide sparge. As shown in FIG. 4, four concentrations of sodium hydroxide solutions (referred to as “caustic” in FIG. 4) are shown as follows: 5% by mass of sodium hydroxide, 4% by mass of sodium hydroxide, 2% by mass of sodium hydroxide, and 1% by mass of sodium hydroxide. Each of the sodium hydroxide solutions was exposed to a carbon dioxide gas sparge over a period of time (minutes). Each sodium hydroxide solution had a starting pH of between 12 and 13 before the sparge, while each solution had a pH of less than 8 after the carbon dioxide gas sparge. Furthermore, each sodium hydroxide solution had a relatively stable alkalinity value before and after the carbon dioxide gas sparge. Depending on the water quality of the inflow 104 of the water from the water supply 116, the sodium hydroxide concentration in the solution 108 in the reaction vessel can be adjusted, before introducing the carbon dioxide gas, in order to generate a desired bicarbonate (HCO₃⁻) alkalinity concentration. Thus, the graph shown in FIG. 4 illustrates the efficacy of the system 100 and method for converting hydroxide alkalinity (OH⁻) to bicarbonate (HCO₃⁻) alkalinity by sparging various concentrations of sodium hydroxide with carbon dioxide gas.

Referring to FIG. 5, there is shown a graph of two sodium hydroxide solutions exposed to a carbon dioxide sparge. As shown in FIG. 5, two concentrations of sodium hydroxide solutions (referred to as “caustic” in FIG. 5) are shown as follows: 2% by mass of sodium hydroxide and 4% by mass of sodium hydroxide. Each of the sodium hydroxide solutions was exposed to a carbon dioxide gas sparge over a period of time (seconds). Each sodium hydroxide solution had a starting pH of between 12 and 13 before the sparge, while each solution had a pH of less than 8 after the carbon dioxide gas sparge. Furthermore, each sodium hydroxide solution had a relatively stable alkalinity value before and after the carbon dioxide gas sparge. Finally, each sodium hydroxide solution had a significant decrease in conductivity from before the carbon dioxide sparge to after the carbon dioxide sparge, and each sodium hydroxide solution had an increase in temperature from before the carbon dioxide sparge to after the carbon dioxide sparge showing a release in heat. FIG. 5 shows the basis for utilizing monitoring equipment (i.e., a conductivity sensor, a pH sensor, and a temperature sensor), such as detector(s) 124, within system 100, to determine when the reaction of converting sodium hydroxide and carbon dioxide gas to bicarbonate solution is complete based on starting sodium hydroxide concentrations of 2% and 4%. Thus, the graphs shown in FIG. 5 also illustrate the efficacy of the system 100 and method for converting hydroxide alkalinity (OH⁻) to bicarbonate (HCO₃⁻) alkalinity by sparging various concentrations of sodium hydroxide with carbon dioxide gas.

While exemplary designs have been described above in the detailed description, those of ordinary skill in the art will understand that the exemplary designs of the present disclosure can be further modified within the spirit and scope of this disclosure. Therefore, the above-described exemplary designs should not be considered to limit the scope of the appended claims.

1. A system for generating bicarbonate solution, comprising:
a reaction vessel comprising an inflow of water (H₂O) and sodium hydroxide (NaOH), wherein the water and the sodium hydroxide combine to form a solution in the reaction vessel;
a gas sparger in fluid communication with the reaction vessel, the gas sparger comprising an inflow of gas comprising carbon dioxide (CO₂) into the solution in the reaction vessel;
at least one flow regulating component upstream from the reaction vessel and in-line with at least one of the following: the inflow of the water, the inflow of the sodium hydroxide, the inflow of the gas comprising carbon dioxide, or any combination thereof; and
a controller in communication with the at least one flow regulating component,
wherein the sodium hydroxide and the carbon dioxide react to form at least bicarbonate (HCO₃⁻) in the solution.

2. The system for generating the bicarbonate solution of claim 1, wherein the controller is configured to control a flow of the inflow of the water, the inflow of the sodium hydroxide, and the inflow of the gas comprising carbon dioxide.

3. The system for generating the bicarbonate solution of claim 1, wherein the at least one flow regulating component comprises at least one of the following: a valve, a pump, a rotameter, a nozzle, a solids feeder, a flow meter, or any combination thereof.

4. The system for generating the bicarbonate solution of claim 1, further comprising:
a water supply upstream from the reaction vessel and in-line with at least the inflow of the water.

5. The system for generating the bicarbonate solution of claim 1, further comprising:
a water softener upstream from the reaction vessel and in-line with at least the inflow of the water, wherein the water softener is configured to soften the water before the inflow into the reaction vessel.

6. The system for generating the bicarbonate solution of claim 1, further comprising:
a sodium hydroxide holding vessel upstream from the reaction vessel and in-line with at least the inflow of the sodium hydroxide, wherein the sodium hydroxide comprises a liquid solution in the holding vessel.

7. The system for generating the bicarbonate solution of claim 6, wherein the liquid solution is between 30 and 60% by mass of the sodium hydroxide.

8. The system for generating the bicarbonate solution of claim 1, further comprising:
a pressure vessel upstream from the gas sparger and in-line with at least the inflow of the gas comprising carbon dioxide, wherein the pressure vessel is configured to hold carbon dioxide in liquid form.

9. The system for generating the bicarbonate solution of claim 1, further comprising:
at least one detector in fluid communication with at least one of the following: the inflow of the water, the inflow of the sodium hydroxide, the inflow of the gas comprising carbon dioxide, the solution in the reaction vessel, a headspace of the reaction vessel, or any combination thereof.

10. The system for generating the bicarbonate solution of claim 9, wherein the at least one detector is in communication with the controller.

11. The system for generating the bicarbonate solution of claim 9, wherein the at least one detector is configured to:
detect at least one property of at least one of the following: the inflow of the water, the inflow of the sodium hydroxide, the inflow of the gas comprising carbon dioxide, the solution in the reaction vessel, the gas in the headspace of the reaction vessel, or any combination thereof; and
transmit the at least one property to the controller.

12. The system for generating the bicarbonate solution of claim 11, wherein the at least one property is at least one of the following: a concentration, a pH, a temperature, a pressure, an alkalinity, a conductivity, a flow rate, a mass, a volume, or any combination thereof.

13. The system for generating the bicarbonate solution of claim 1, further comprising:
a gas inlet in fluid communication with the reaction vessel, wherein the gas inlet is configured to introduce a gaseous pressure to at least one of the following: the solution in the reaction vessel, a headspace of the reaction vessel, or a combination thereof.

14. A method for generating bicarbonate solution, comprising:
flowing water (H₂O) into a vessel;
introducing sodium hydroxide (NaOH) into the vessel, wherein the water and the sodium hydroxide combine to form a solution; and
sparging a gas comprising carbon dioxide (CO₂) in the solution,
wherein the sodium hydroxide and the carbon dioxide react to form at least bicarbonate (HCO₃⁻) in the solution.

15. The method for generating the bicarbonate solution of claim 14, further comprising:
controlling a flow of the water, the sodium hydroxide, and the gas comprising carbon dioxide with a controller.

16. The method for generating the bicarbonate solution of claim 14, further comprising:
flowing the water through a water softener before flowing the water into the vessel.

17. The method for generating the bicarbonate solution of claim 14, further comprising:
detecting at least one property of at least one of the following: the water flowing into the vessel, the sodium hydroxide flowing into the vessel, the gas comprising carbon dioxide sparging in the solution, the solution in the vessel, the gas in a headspace of the vessel, or any combination thereof.

18. The method for generating the bicarbonate solution of claim 17, further comprising:
transmitting the at least one property to the controller, wherein the at least one property is at least one of the following: a concentration, a pH, a temperature, a pressure, an alkalinity, a conductivity, a flow rate, a mass, a volume, or any combination thereof.

19. The method for generating the bicarbonate solution of claim 14, further comprising:
introducing a gaseous pressure to at least one of the following: the solution in the vessel, the headspace of the vessel, or a combination thereof.

20. The method for generating the bicarbonate solution of claim 17, further comprising:
transferring the solution from the vessel after detecting the at least one property of at least one of the following: the water flowing into the vessel, the sodium hydroxide flowing into the vessel, the gas comprising carbon dioxide sparging in the solution, the solution in the vessel, the gas in the headspace of the vessel, or any combination thereof.
